(19) United States
(12) Patent Application Publication
(10) Pub. No.: US 2007/0071576 A1
(43) Pub. Date: Mar. 29, 2007

(54) Hybrid screw for composite lumber and wood

(76) Inventors: Mark J. Romano, River Forest, IL (US); Lon E. DeHaitre, Arlington Heights, IL (US)

Correspondence Address: MCANDREWS HELD & MALLOY, LTD, 500 WEST MADISON STREET, SUITE 3400, CHICAGO, IL, 60661, US

(21) Appl. No.: 11/239,491

(22) Filed: Sep. 29, 2005

(51) Int. Cl. F16B 35/06

(52) U.S. Cl. 411/399

(57) ABSTRACT

A screw for use in a composite lumber member or a wood member has at least one disruptive surface that cuts composite material away from the composite lumber member as the screw is driven into the member to prevent a mound and/or strings from being formed that are attached to the composite lumber member when the screw is set therein. The screw may be used with conventional wood members wherein the screw of the present invention provides increased clamping when driven into a wood member to fasten the wood member to a support member or the like.

### CROSS-REFERENCE TO RELATED APPLICATIONS

N/A

### STATEMENT REGARDING FEDERALLY SPONSORED RESEARCH OR DEVELOPMENT

N/A

### TECHNICAL FIELD

The present invention is directed to a screw for use with a composite lumber as well as wood and more particularly, to such a screw that prevents a mound of composite material from forming about the screw head when the screw is driven into a composite lumber member and which further provides increased clamping when the screw is inserted into a wood member to fasten the wood member to a support member.

### BACKGROUND OF THE INVENTION

Composite lumber is a new type of lumber that is formed of a composite material that typically includes wood fibers, such as sawdust, a plastic and an adhesive materials, such as glue, to bond the composite materials together to form a composite lumber member, such as a plank. Composite lumber is often used in outdoor decks because of its increased durability as compared to conventional wood planks. Known screws that are currently used to attach a composite lumber member to another member have been found to cause irregularities in the composite lumber member when those screws are driven into the member. Specifically, when a known screw 2 is driven into a composite lumber member 4 as shown in FIG. 1, the screw forces the composite material that is displaced by insertion of the screw into the member to form a mound 6 about the head of the screw and/or strings 8 of the composite material where the mound 6 and strings 8 are still attached to the composite lumber member 4 when the screw 2 is set. Because the mound 6 and strings 8 of composite material are still attached to the composite lumber member when the screw is set, neither the mound or the strings can easily be removed. These mounds and strings form undesirable irregularities in the otherwise flat surface of the composite lumber member.

### BRIEF SUMMARY OF THE INVENTION

In accordance with the present invention, the disadvantages of prior screws used in composite lumber members, as discussed above, have been overcome. The screw of the present invention has at least one disruptive surface that cuts composite material away from the composite lumber member as the screw is driven into the member to prevent a mound and/or strings from being formed that are attached to the composite lumber member when the screw is set therein. Moreover, the screw of the present invention may be used with conventional wood members wherein the screw of the present invention provides increased clamping when driven into a wood member to fasten the wood member to a support member or the like.

More particularly, the screw of the present invention includes a head portion at an end of the screw opposite a pointed end of the screw. The screw has a threaded portion that extends to or adjacent the pointed end of the screw. The screw also has a cutter portion disposed between the head and threaded portions of the screw, the cutter portion having a disruptive surface that cuts composite material away from the composite member as the screw is driven into the composite member to prevent irregularities in the otherwise flat surface of the composite lumber member when the screw is set. More particularly, the screw of the present invention prevents a mound of composite material from being formed about the head of the screw when the screw is set into the composite lumber member where the mound is still attached to the composite lumber member. Similarly, the screw of the present invention prevents strings of the composite material from being formed where the strings are still attached to the composite lumber member when the screw is set.

In accordance with another feature of the present invention, the screw includes a head portion at an end of the screw opposite a pointed end of the screw wherein the head portion has an upper surface and a bottom surface with a recess formed in the bottom surface for collecting material. The screw has a threaded portion extending to or adjacent the pointed end of the screw. The screw also includes a cutter portion disposed between the head and the threaded portions of the screw wherein the cutter portion has a disruptive surface that cuts composite material away from the composite member as the screw is driven into the composite member and wherein excess cut composite material is captured in the recess under the head of the screw.

In accordance with another feature of the present invention, a screw is provided having a head portion at an end of the screw opposite a pointed end of the screw and a threaded portion that extends to or adjacent the pointed end of the screw. A diamond knurl portion is disposed between the head and the threaded portions of the screw wherein the diamonds of the diamond knurl portion have a length that is greater than their width.

In accordance with another feature of the present invention, the threaded portion of the screw has a thread with an asymmetrical cross section so that the thread has a bottom surface that is at a first angle with respect to a line that is perpendicular to the longitudinal axis of the screw and the thread a top surface that is at a second angle with respect to a line that is perpendicular to the longitudinal axis of the screw wherein the first angle is greater than the second angle.

These and other objects and advantages and novel features of the present invention, as well as details of an illustrated embodiment thereof, will be more fully understood from the following description and drawings.

### BRIEF DESCRIPTION OF THE SEVERAL VIEWS OF THE DRAWING

FIG. 1 is a cross sectional view of a prior art screw inserted into a composite lumber member illustrating the mound and strings that are formed when known screws are driven into a composite lumber member;

FIG. 2 is a perspective view of the screw of the present invention;

FIG. 3 is a longitudinal cross sectional view of the asymmetric thread of the threaded portion of the screw;

FIG. 4 is a cross sectional view of a threaded portion of the screw of the present invention taken along section B-B of FIG. 2;

FIG. 5 is a cross sectional view of the cutter portion of the screw taken along section A-A of FIG. 2 and also illustrates serrations on a bottom surface of the screw head;

FIG. 6 is a top view of the head portion of the screw of FIG. 2; and

FIG. 7 is an illustration of the screw of the present invention with cut composite material adhered to the screw when the screw is removed from a composite lumber member.

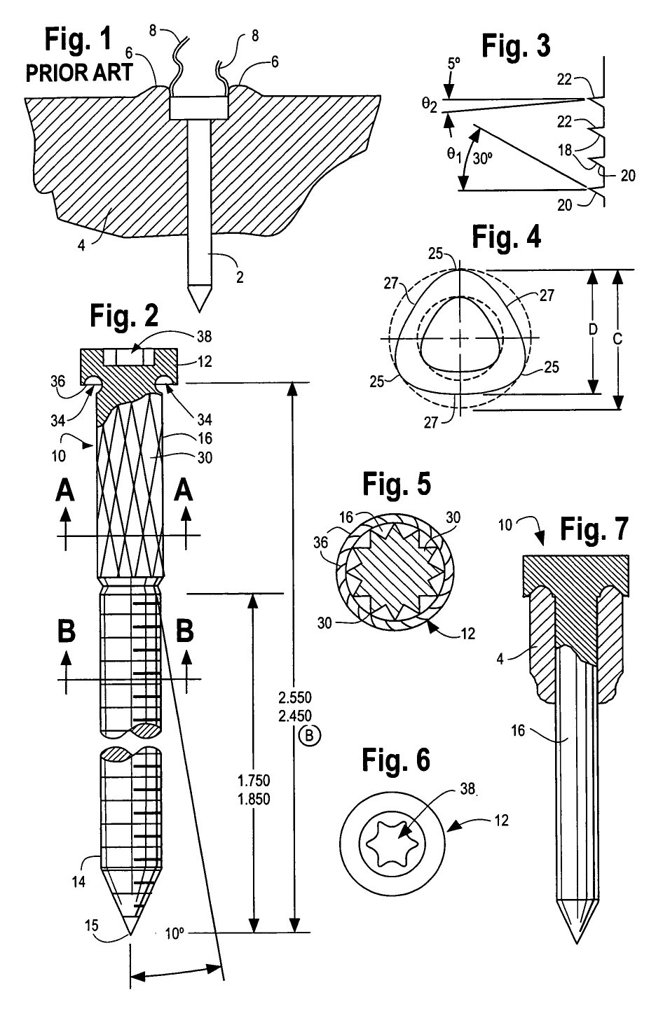

### DETAILED DESCRIPTION OF THE INVENTION

A screw 10 in accordance with the present invention, as shown in FIG. 2, for use with a composite lumber member or a conventional wood member includes a head 12, a threaded portion 14 that extends to adjacent a pointed end 15 of the screw 10; and a cutter portion 16 that is disposed between the head 12 and the threaded portion 14 of the screw. The cutter portion 16 of the screw 10 has a disruptive surface, as discussed in detail below, that cuts composite material away from a composite lumber member as the screw is driven into the composite member so as to prevent a mound of composite material from being formed about the head of the screw when the screw is set into the composite member. As such, no irregularities are formed in the surface of a composite lumber member when the screw 10 of the present invention is driven into the member.

In a preferred embodiment, the threaded portion 14 of the screw 10 includes one or more helical threads that extend from the bottom of the cutter portion 16 adjacent to the pointed end 15 of the screw or, in a preferred embodiment, that extend to the point 15 of the screw 10. The thread preferably has an asymmetrical form as shown in the cross sectional view of the thread taken through a longitudinal axis of the screw 10 as shown in FIG. 3. More specifically, the thread 18 has an asymmetrical longitudinal cross section such that the thread has a bottom surface 20 that is at a first angle θ₁ with respect to a line 21 that is perpendicular to the longitudinal axis of the screw. The thread 18 has a top surface 22 that is at a second angle θ₂ with respect to a line that is perpendicular to the longitudinal axis of the screw wherein the first angle θ₁ is greater than the second angle θ₂. In a preferred embodiment, the first angle θ₁ is approximately 30°; whereas the second angle θ₂ is approximately 5°. However, the asymmetrical thread can be formed with various combinations of angles that produce a barbed like profile. This profile results in a somewhat taller and sharper thread than a conventional, symmetrical thread. As such, the asymmetrical thread produces more of a cutting action as opposed to a wedging action as it generates female threads when driven into a member such as a composite lumber member or a conventional wood member. This feature results in a number of advantages. The asymmetrical thread 18 lowers the driving torque due to the thin profile of the thread 18. Moreover, the asymmetrical thread reduces the amount of material evacuated from the member into which the screw is driven as the screw is being set due to the small angle on the top or upper surface 22 of the thread. The asymmetrical thread also results in greater clamping energy and higher pull out values due to the barbed thread configuration and the deeper footprint that results as the asymmetrical thread is set into the receiving material. The asymmetrical thread also generates less heat when the screw is set due to the reduced thread profile and mass that intrudes into the material of the member in which the screw 10 is set. Moreover, the design of the asymmetrical threads prevent splitting of the member into which the screw is driven.

In addition to being asymmetrical, the thread 18 preferably has a full tri-lobular form as depicted in FIG. 4. The preferred dimension D of the tri-lobular thread shown in FIG. 4 is 0.180+/−0.003 inches. The full tri-lobular thread form has a number of advantages when driving the screw into varying density composite lumber members or hardwood members as well as other unforgiving materials. Specifically, the tri-lobular thread form lowers the driving torque since the resistance is concentrated and distributed to the three lobes 25 of the form at 120° increments. The flatter surfaces 27 between the lobes of the thread also serve as a relief area for the displaced and compressed material of the member, into which the screw is being driven, to flow. Moreover, the tri-lobular form eliminates splitting of the member into which the screw is driven. That is because compressed or displaced material of the wood or composite lumber member formed as the threads 18 form female threads in the member, is vented into the flat areas 27 between the lobes. These flatter areas function as relief surfaces running the length of the threaded portion 14 in the axial direction. Further, once the screw 10 is set into the member in which it is driven, cold creep, memory and elasticity of the member moves some of the mass of the members material into and against the flatter areas between the lobes. This increased surface creates a self-locking feature which discourages loosening of the screw.

In a preferred embodiment, the threads 18 of the threaded portion 14 of the screw 10 extend to the sharp point 15 of the screw. The sharp point 15 holds the screw tip in position at the start of the screw being driven into a material, and also eases movement of the screw into the material with continued rotation of the screw. The fully formed threads extending to the point 15 assist in grabbing the material of the wood or composite lumber member to help pull the screw into the member as the screw is being rotated. For a composite lumber member, the quicker the screw moves into the composite material, the less heat that is generated by friction. It is desirable to reduce the friction generated heat because heat quickly softens the plastic in the composite material and reduces its tensile strength, thereby eroding the composite material's ability to pull the screw into the member because the female threads are not being formed. Heat can also cause the thermal plastics in the composite material to puddle and mush. When the screw 10 is being driven into wood, the rate at which the screw is moved into the wood member is facilitated by the thread form at the point 15 since the thread is capable of generating a mirror image female thread form in the wood. The more defined the thread form is, the stronger the created female thread in the wood member and the greater the resulting pull of the screw into the wood member. In summary, a sharp defined point 15 and the fullest possible thread forms that extend from the tip or point 15 up to the cutting portion 16, the faster and easier the screw starts and moves through the member in which it is being driven into. It is noted that the screw tip may be formed with a shank slotted point, if desired, commonly known within the industry standard as a type 17 shank slot. This configuration results in a 25% or a full quadrant of the point 15 being removed. It is noted, however, that a screw in accordance with the present invention need not have a shank slotted point.

The cutter portion 16 of the screw 10 is disposed between the threaded portion 14 and the head 12. In a preferred embodiment, the length of the cutting portion 16 is approximately 20% to 35% of the total length of the cutting portion 16 and the threaded portion 14, i.e. the length of the screw up to the base of the head 12. In a preferred embodiment, the length of the threaded portion 14 is approximately 1.75-1.85 inches whereas the total length of the threaded portion 14 and the cutter portion 16 from the point 15 to the base of the head 12 is 2.45-2.55 inches. Obviously, these dimensions can be increased or decreased for different screw applications.

In preferred embodiment, the cutter portion 16 is formed as a diamond knurl wherein each of the diamonds forming the knurls are asymmetric such that the length of each of the diamonds is greater than the width of the respective diamond. In a preferred embodiment, twelve teeth on the diameter at a 10° lead versus the axis diamond knurl is utilized. The diamond knurl is formed by left female threads and right female threads which cross each other. These female threads form cavities in the body of the cutter portion 16 of the screw wherein the cavities outline a diamond pattern. When the cavities outlining the diamond pattern are formed, a small protuberance or knurl 30 is formed generally centered within each of the diamonds. These knurls 30 form serrations about the periphery of the cutter portion 16 of the screw 10. The knurls 30 or serrations of the diamond knurl portion 16 are shown in the cross sectional view of the cutter portion 16 depicted in FIG. 5. The knurls 30 serve as cutters or shredders to cut composite material away from the composite lumber member as the screw 10 is being driven into the composite member. As the screw 10 is being driven into a composite lumber member, the composite material cut away from the composite member by the knurls 30 is drawn into and compressed into the diamond shaped cavities of the diamond knurl 16 so that the cut material is drawn down into the hole created by the screw. The elongated, asymmetric diamond pattern of the cutter portion 16 maximizes the amount of cut composite material that is absorbed into the cavities at 90° with respect to the direction of rotation. As such, the cavities of the diamond knurl or cutter portion 16 compress into the diamond cavities the composite material that has been cut or sheared by the screw during rotation of the screw body as it is being driven into a composite lumber member. They also serve to pull the cut or evacuated composite material down into the hole created by the hole in the composite member that is formed as the screw is being driven into the member. Moreover, the diamond knurl or cutter portion 16 increases the hole diameter formed in the composite member so as to ease draw-up action or clamping of the composite member to a second member as the screw is being set. The diamond knurl or cutter portion 16 is also advantageous when the screw 10 is being driven into a wood member since the knurls or cutters similarly increase the diameter of the hole that is created in the wood member as the screw is being driven therein so as to ease torque and allow for increased clamping when the wood member is being fastened to a second member by the screw 10.

The head 12 of the screw 10 preferably has a recess 34 formed in a bottom surface 36 of the head 12. This recess may be formed as a U-cut in the bottom surface of the head 12. This recess or undercut in the bottom surface of the head 12 accepts and compacts any cut material of the wood or composite lumber member that is pushed up as the screw member is being driven into the member. Although the majority of the material cut away from the wood or composite lumber member is compressed into the cavities of the diamond knurl, the recess 34 in the head 12 captures and compresses any excess cut material. As such, it has been found that the screw 10 prevents a mound of composite material from being formed about the screw head 12 when the screw 10 is driven into and set in a composite lumber member. Similarly, the cutter portion 16 of the screw 10, alone or in combination with the recess 34 of the head, prevents a mound or strings of compressed material from being formed about the screw head. As such, when the screw 10 of the present invention is set into composite lumber, no irregularities are formed in the flat surface of the composite lumber. It is clear that the cutter portion 16 of the screw 10 actually cuts or shears the composite material away from the composite lumber member as the screw 10 is being driven into the member because when the screw 10 is removed, the cut, composite material 4 adheres to the cutter portion 16 of the screw as shown in FIG. 7. In a preferred embodiment, the bottom surface of the head also has a slight bevel on the order of 2° that extends from the sidewall of the head upwards to the outer surface of the recess 34. Moreover, the beveled bottom surface of the head 12 may be formed with serrations 36 as shown in FIG. 5. The serrations 36 may be of the reverse scallop type. These serrations also prevent a mound or strings of composite material from forming about the head 12 as the screw is set. The serrations 36 cut into the composite lumber member or wood member cleanly and the counter-clockwise direction of the serrations 36 drives displaced material into the recess 34.

It is noted, that the head 12 of the screw 10 can be formed with an oversized driving recess 38 in a top surface of the head 12. For example, the recess may be one size up from the size of the recess that is normally used for a given diameter of the screw so as to improve bit engagement, increase the control that the installer has, and prolong the life of the driving bit.

Many modifications and variations of the present invention are possible in light of the above teachings. Thus, it is to be understood that, within the scope of the appended claims, the invention may be practiced otherwise than as described hereinabove.

What is claimed and desired to be secured by Letters Patent is:

1. A screw for use in a composite lumber member formed of a composite materials that includes at least some plastic and adhesive comprising:
a head portion at an end of the screw opposite a pointed end of the screw;
a threaded portion extending to or adjacent the pointed end;
a cutter portion disposed between the head and threaded portions of the screw, the cutter portion having a disruptive surface that cuts composite material away from the composite member as the screw is driven into the composite member to prevent a mound of composite material from being formed about the head of the screw when the screw is set into the composite lumber member.

2. A screw for use in a composite lumber member as recited in claim 1 wherein the disruptive surface of the cutter portion is a serrated surface.

3. A screw for use in a composite lumber member as recited in claim 1 wherein the disruptive surface has a diamond knurl pattern wherein the height of a diamond is greater than the width of the diamond.

4. A screw for use in a composite lumber member as recited in claim 1 wherein the head portion of the screw has a bottom surface with a recess formed therein to capture excess cut composite material under the head.

5. A screw for use in a composite lumber member as recited in claim 4 wherein the bottom surface of the head has serrations about the periphery thereof, the serrations extending from a sidewall of the head to the recess.

6. A screw for use in a composite lumber member as recited in claim 1 wherein the threaded portion includes a thread having an asymmetrical cross section.

7. A screw for use in a composite lumber member as recited in claim 5 wherein the asymmetrical thread has a bottom surface that is at a first angle with respect to a line that is perpendicular to the longitudinal axis of the screw and a top surface that is at a second angle with respect a line that is perpendicular to the longitudinal axis of the thread wherein the first angle is greater than the second angle.

8. A screw for use in a composite lumber member as recited in claim 1 wherein the threads of the threaded portion extend to the point of the screw.

9. A screw for use in a composite lumber member as recited in claim 1 wherein the length of the cutter portion is approximately 20% to 35% of the total length of the cutter portion and the threaded portion.

10. A screw for use in a composite lumber member as recited in claim 1 wherein the threads of the threaded portion have a trilobular form.

11. A screw for use in a composite lumber member as recited in claim 1 wherein the head has a driving recess formed in an upper surface and the driving recess is oversized for the screw diameter.

12. A screw for use in a composite lumber member formed of a composite material that includes at least some plastic and adhesive comprising:
a head portion at an end of the screw opposite a pointed end of the screw, the head portion having a bottom surface with a recess formed therein for collecting material;
a threaded portion extending to or adjacent the pointed end;
a cutter portion disposed between the head and threaded portions of the screw, the cutter portion having a disruptive surface that cuts composite material away from the composite member as the screw is driven into the composite member wherein excess cut composite material is captured under the head.

13. A screw for use in a composite lumber member as recited in claim 12 wherein the disruptive surface of the cutter portion is a serrated surface.

14. A screw for use in a composite lumber member as recited in claim 12 wherein the disruptive surface has a diamond knurl pattern wherein the height of a diamond is greater than the width of the diamond.

15. A screw for use in a composite lumber member as recited in claim 12 wherein the bottom surface of the head has a bevel extending from a sidewall of the head upward and inward and serrations formed on the bevel.

16. A screw for use in a composite lumber member as recited in claim 12 wherein the threaded portion includes a thread having an asymmetrical cross section.

17. A screw for use in a composite lumber member as recited in claim 16 wherein the asymmetrical thread has a bottom surface that is at a first angle with respect to a line that is perpendicular to the longitudinal axis of the screw and a top surface that is at a second angle with respect a line that is perpendicular to the longitudinal axis of the thread wherein the first angle is greater than the second angle.

18. A screw for use in a composite lumber member as recited in claim 12 wherein the threads of the threaded portion extend to the point of the screw.

19. A screw for use in a composite lumber member as recited in claim 12 wherein the length of the cutting portion is approximately 20% to 35% of the total length of the cutting portion and the threaded portion.

20. A screw for use in a composite lumber member as recited in claim 12 wherein the threads of the threaded portion have a tri-obular form.

21. A screw for use in a composite lumber member as recited in claim 12 wherein the head has a driving recess formed in an upper surface and the driving recess is oversized for the screw diameter.

22. A screw comprising:
a head portion at an end of the screw opposite a pointed end of the screw;
a threaded portion extending to or adjacent the pointed end; and
a diamond knurl portion disposed between the head and the threaded portions wherein the diamonds of the diamond knurl portion have a length that is greater than the width of the diamonds.

23. A screw as recited in claim 22 wherein the diamond knurl portion cuts the material into which the screw is set.

24. A screw as recited in claim 22 wherein the diamond knurl portion cuts the material into which the screw is set and wherein the head portion of the screw has a bottom surface with a recess formed therein to capture cut material.

25. A screw as recited in claim 24 wherein the bottom surface of the head has serrations about the periphery thereof, the serrations extending from a sidewall of the head to the recess.

26. A screw as recited in claim 22 wherein the threaded portion includes a thread having an asymmetrical cross section such that the thread has a bottom surface that is at a first angle with respect to a line that is perpendicular to the longitudinal axis of the screw and a top surface that is at a second angle with respect a line that is perpendicular to the longitudinal axis of the thread wherein the first angle is greater than the second angle.

27. A screw as recited in claim 22 wherein the threads of the threaded portion extend to the point of the screw.

28. A screw as recited in claim 22 wherein the length of the diamond knurl portion is approximately 20%-35% of the total length of the diamond knurl portion and the threaded portion.

29. A screw as recited in claim 22 wherein the threads of the threaded portion have a tri-obular form.

30. A screw comprising:
a head portion at an end of the screw opposite a pointed end of the screw, the head portion having a bottom surface with a recess formed therein for collecting material;
a threaded portion extending to or adjacent the pointed end; and
a diamond knurl portion disposed between the head and the threaded portion wherein the diamonds have a length that is greater than their width.

31. A screw comprising:
a head portion at an end of the screw opposite a pointed end of the screw;
a threaded portion with a thread extending to or adjacent the pointed end, the thread having an asymmetrical cross section so that the thread has a bottom surface that is at a first angle with respect to a line that is perpendicular to the longitudinal axis of the screw and a top surface that is at a second angle with respect a line that is perpendicular to the longitudinal axis of the thread wherein the first angle is greater than the second angle;
a diamond knurl portion disposed between the head and the threaded portion wherein the diamonds have a length that is greater than their width.

32. A screw comprising:
a head portion at an end of the screw opposite a pointed end of the screw, the head portion having a bottom surface with a recess formed therein for collecting material;
a threaded portion with a thread extending to or adjacent the pointed end, the thread having an asymmetrical cross section so that the thread has a bottom surface that is at a first angle with respect to a line that is perpendicular to the longitudinal axis of the screw and a top surface that is at a second angle with respect a line that is perpendicular to the longitudinal axis of the thread wherein the first angle is greater than the second angle; and
a diamond knurl portion disposed between the head and the threaded portion wherein the diamonds have a length that is greater than their width.

33. A screw as recited in claim 32 wherein the threads of the threaded portion extend to the point of the screw.

34. A screw as recited in claim 32 wherein the threads of the threaded portion have a tri-obular form.

35. A screw as recited in claim 32 wherein the length of the diamond knurl portion is approximately 20%-35% of the total length of the diamond knurl portion and the threaded portion.
